(19) United States
(12) Patent Application Publication
(10) Pub. No.: US 2023/0333570 A1
(43) Pub. Date: Oct. 19, 2023

(54) AUTONOMOUS FIRE EXTINGUISHER

(71) Applicant: OneEvent Technologies, Inc., Mount Horeb, WI (US)

(72) Inventor: Douglas J. Frederick, Eau Claire, WI (US)

(21) Appl. No.: 18/134,439

(22) Filed: Apr. 13, 2023

Related U.S. Application Data
(60) Provisional application No. 63/330,632, filed on Apr. 13, 2022.

(51) Int. Cl. G05D 1/02; A62C 27/00; G01S 1/04

(52) U.S. Cl. CPC G05D 1/0276; A62C 27/00; G01S 1/0423; G05D 1/0214

(57) ABSTRACT

A system for and method of fighting fires using a monitoring system in communication with a hazard mitigation robot. The monitoring system is comprised of a plurality of sensors receiving data that is analyzed by the monitoring system to identify a potential fire. When a potential fire is detected, the monitoring system dispatches one or more autonomous hazard mitigation robots which navigate to an indicated location, confirm the presence of a fire, and attempt to extinguish the fire using fire suppressant material carried onboard the hazard mitigation robot.

### CROSS-REFERENCE TO RELATED APPLICATIONS

This application claims priority to U.S. Provisional application 63/330,632 filed on Apr. 13, 2022, which is incorporated herein by reference in its entirety.

### TECHNICAL FIELD

The present invention relates generally to a system for and method of detecting hazardous conditions and providing mitigating actions related to those conditions.

### BACKGROUND

Fire regularly causes smoke and structural damage to homes, businesses, and their contents. Worse than damage to “things”, occupants of these homes and businesses can face serious injury or death. The use of smoke detectors, alarm systems, and sprinkler systems has done much to mitigate damage and injuries but there is still room for improvement. Robots are used by the military, safety agencies, law enforcement, and industry to address hazardous situations including fires. However, these robots are often large, unwieldy for ordinary homes and small businesses, and can be very costly. Furthermore, they are not generally autonomous in that they require a human operator to direct them to the source of the hazardous situation and are generally used to extend the “reach” of their operator such that the operator can remain at a safe distance from the hazard. The large size and cost as well as the requirement for human control make these robots impractical for use in many homes and businesses. What is needed is a cost-effective hazard mitigation robot system that is optimized for home and small businesses use that has at least a partially autonomous operation.

### SUMMARY

In an exemplary embodiment of a system for detecting and fighting fires the system comprises a plurality of building sensors, a monitoring system that receives data from the plurality of sensors, the monitoring system comprising a receiver/transmitter and a hazard mitigation robot. The hazard mitigation robot comprising a drive system configured to move the robot from a first location to a second location, a processor, a plurality of sensors, a receiver/transmitter in communication with the monitoring system, instructions that when performed by the monitoring system, cause the monitoring system to receive data from the plurality of building sensors, analyzing the received data to determine if a fire or other hazardous condition is present, identify the location of the fire or hazardous condition, provide instructions to the hazard mitigation robot, instructions that when performed by the processor of the hazard mitigation robot, cause the hazard mitigation robot to receive navigation instructions from the monitoring system which comprise the location of the fire, navigate to the location of the fire, receive data from a condition sensor, analyze the received sensor data and react to the hazardous condition based on the results of the analysis of the received sensor data.

These and other aspects and implementations are discussed in detail below. The foregoing information and the following detailed description include illustrative examples of various aspects and implementations and provides an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

These and other features and advantages of the present invention will become better understood with regard to the following description and accompanying drawings in which:

FIG. 1 illustrates a block diagram of a hazardous condition mitigation system according to an exemplary embodiment;

FIG. 2 illustrates a block diagram of an exemplary embodiment of a hazardous condition mitigation system implemented in a residence;

FIG. 3 illustrates a block diagram of a hazard mitigation robot configured as a firefighting robot according to an exemplary embodiment;

FIG. 4 illustrates a block diagram of a hazardous condition mitigation robot configured with a dispenser according to an exemplary embodiment;

FIG. 5 illustrates a flowchart of the steps taken to detect and extinguish a fire by an exemplary embodiment; and

FIG. 6 illustrates a flowchart of the steps taken by an exemplary embodiment of a hazard mitigation robot to extinguish a fire.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

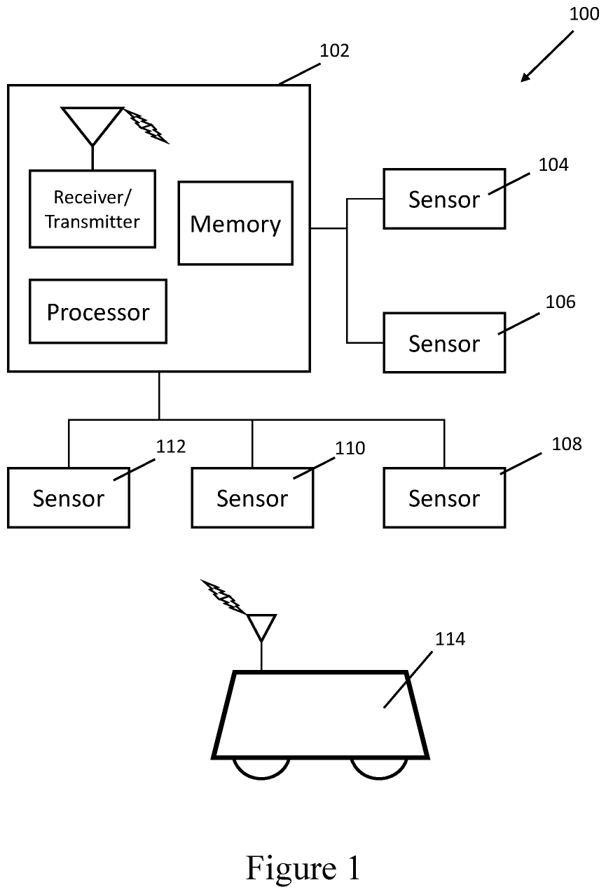

FIG. 1 illustrates a block diagram of a hazardous condition mitigation system 100 according to an exemplary embodiment. As shown, a monitoring system 102 is in communication with a plurality of sensors 104, 106, 108, 110, and 112. Although illustrated similarly, these sensors can be smoke sensors, temperature sensors, gas sensors, motion sensors, particulate sensors, and other sensor types that can detect hazardous conditions. Additionally, a sensor can combine several functions (i.e., smoke, temperature, gas, etc.) into a single sensor installation. Although illustrated with a direct connection, exemplary embodiments may communicate wirelessly between the monitoring system and the various sensors using technologies capable of transmitting over shorter distances (for example, without limitation, Wi-Fi (including TCP/IP), Wi-Max, Bluetooth®, LoRa, NFC, Zigbee, and the like) or over longer distances (for example, without limitation, cellular or mobile phone communications, wireless radio channels, local area network (LAN), metropolitan area network (MAN), wide area network (WAN), world wide web (WWW), the Internet, and the like). Also illustrated is a hazard mitigation robot 114 in electronic communication with the monitoring system 102. As previously described, this electronic communications means could include, but is not limited to Wi-Fi (including TCP/IP), Wi-Max, Bluetooth®, LoRa, NFC, Zigbee, local area network (LAN), metropolitan area network (MAN), wide area network (WAN), world wide web (WWW), the Internet, and the like. In certain exemplary embodiments, the hazard mitigation robot 114 is autonomous in that once a command is received from the monitoring system, the hazard mitigation robot 114 proceeds to the indicated location of the hazard and attempts to mitigate the hazardous condition without requiring additional instructions.

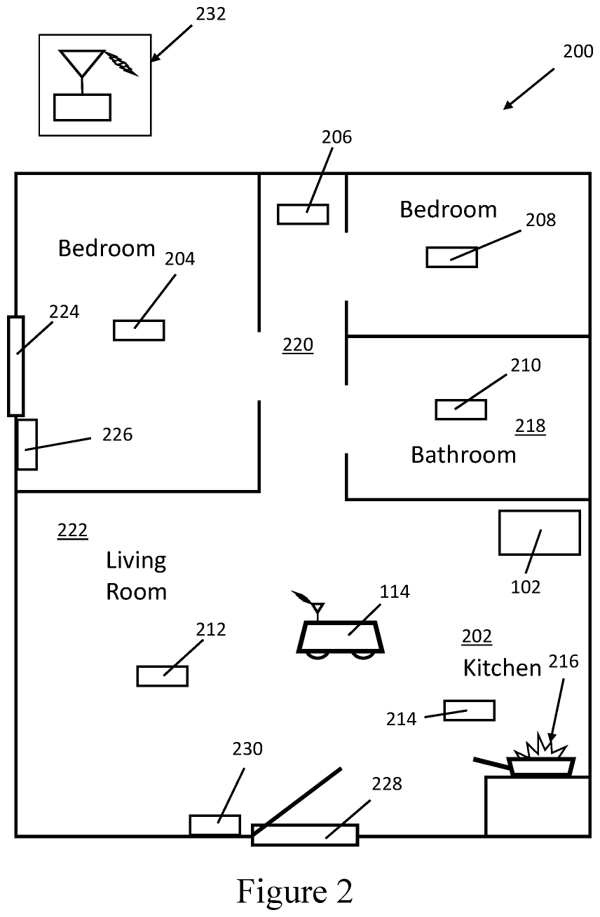

In an exemplary embodiment, the hazardous condition mitigation system 100 is located in a residence. FIG. 2 illustrates such a residence 200. As illustrated, the residence 200 has a plurality of rooms. In the exemplary embodiment, the monitoring system 102 is located in the kitchen area 202 of the residence 200. A central location such as is illustrated may provide an optimal path of electronic communication with the various other components of an exemplary hazardous condition mitigation system 100. As illustrated, sensors 204, 206, 208, 210, 212, and 214 are positioned at various locations throughout the residence 200. In the illustrated example, a fire 216 has started in the kitchen 202. In the exemplary embodiment, the sensor 214 may be a smoke detector or other device for detecting a fire. In certain exemplary embodiments, the sensor 214 may be optimized for use in a kitchen or other specific environment. For example, the sensor may be adapted to ignore steam produced by a boiling pot or be capable of discriminating between a smoking pan, which may be the ordinary result of cooking, and a grease fire that has started as the result of unattended cooking. As previously noted, in exemplary embodiments sensors may combine several detection methods. For example, in an exemplary embodiment a sensor may combine obscuration detection, temperature detection, gas detection, and motion detection to identify whether there is an unattended fire or simply a burnt piece of toast. In certain exemplary embodiments, the monitoring system 102 learns the characteristics of each room and sets thresholds according to what has been determined to be normal behavior for a given period of time. For example, the sensor 210 located in a bathroom 218 may regularly sense obscuration caused by a steamy shower on weekday mornings. The monitoring system 102 may learn this behavior and adjust its notification limits during those times. Alternatively, the monitoring system 102 may utilize sensors located proximately to the sensor 210. For example, in an exemplary embodiment, the monitoring system 102 may cause the sensor 206 located in a hallway 220 to be more sensitive to smoke, gases, or temperature during the time that a shower is ordinarily taken in the bathroom 218 by causing the sensor 210 located in the bathroom 218 to be less sensitive to obscuration to account for the higher than normal level of obscuration caused by steam from the shower. In certain exemplary embodiments, the hazardous condition mitigation system may determine if there is activity in the house which may indicate that someone is moving about. This information is used in such a system to adjust detection thresholds based on a likelihood that the condition detected by a sensor is the result of ordinary behavior. For example, the aforementioned shower would not likely be occurring if there was no one present in the house at the time a level of obscuration was detected.

In an exemplary embodiment, the hazardous condition mitigation system 100 may be equipped with one or more hazard mitigation robots 114. In the event that a fire 216 is detected in the kitchen 202, the monitoring system 102 communicates with the hazard mitigation robot 114 to provide instructions such that the hazard mitigation robot 114 travels to the kitchen 202. In certain exemplary embodiments, the hazard mitigation robot 114 may employ additional sensors in an attempt to verify that a fire 216 actually exists in the kitchen 202. Should the hazard mitigation robot 114 not detect a fire 216 or receive information that is inconclusive, the hazard mitigation robot 114 may communicate that determination to the monitoring system 102.

In certain exemplary embodiments, the monitoring system 102 may attempt to contact the remote monitoring center 232 for instruction. For example, in certain circumstances, the monitoring system 102 may detect conditions that indicate a severity that is likely unable to be addressed by the hazard mitigation robot 114 (or robots) available to a monitoring system 102 to address the condition. Emergency services may be contacted for further instructions in conjunction with the attempts by the monitoring system 102 to mitigate the detected conditions or assist occupants of the structure being monitored. In other exemplary embodiments, the hazard mitigation robot 114 is configured with a camera such that images of the kitchen 202 may be communicated to a monitoring center or emergency services such that real-time conditions within the kitchen may be observed. Thus, the hazard mitigation robot 114 may be able to assist emergency services personnel in their determination as to whether a hazardous condition actually exists.

In certain exemplary embodiments, the hazard mitigation robot 114 may periodically travel through the residence 200. In addition to supplementing the existing sensor network (204, 206, 208, 210, 212, and 214), this activity may be used to create a virtual map of the residence 200 such that the hazard mitigation robot 114 will have information necessary to navigate to an area of the residence 200 as the result of instructions from the monitoring system 102. In certain exemplary embodiments, the hazard mitigation robot 114 may comprise sensors that can be used to augment those sensors (204, 206, 208, 210, 212, and 214) located at fixed locations within the residence 200. For example, in the event that a sensor 212 located in the living room 222 detects a rise in temperature, the hazard mitigation robot 114 can be instructed to travel to the living room 222 to confirm the temperature rise and also to determine if smoke, gas, or other hazardous conditions are detectable. For example, the sensor 222 may detect a temperature rise that is not confirmed by the robot 114. In such a circumstance, the monitoring system 102 may contact a monitoring center and transmit images and sensor data so that monitoring center personnel can determine if the temperature rise is actually an indication of a hazardous condition. The hazard mitigation robot 114, being mobile, may also detect hazardous conditions that may not be detectable by the fixed sensors (204, 206, 208, 210, 212, and 214).

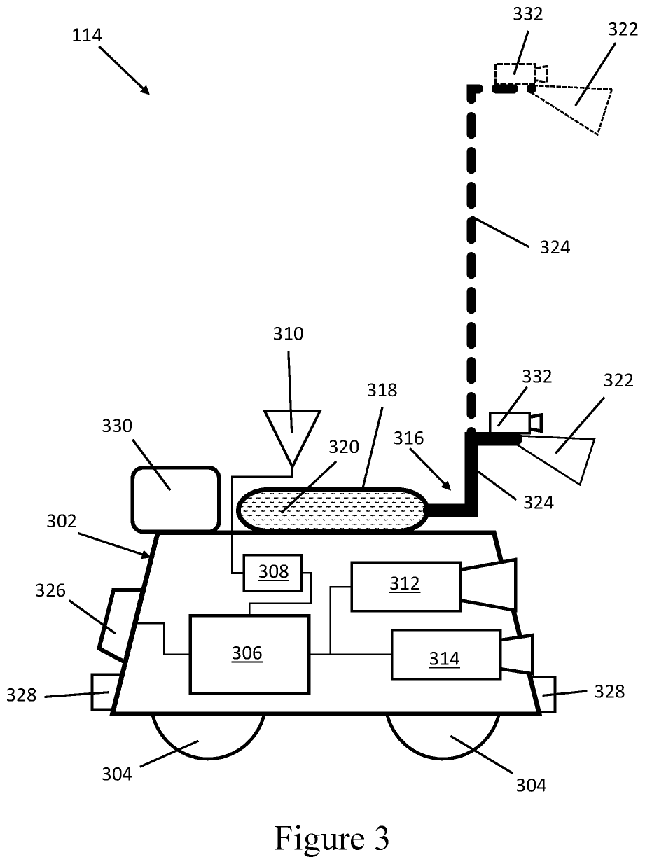

FIG. 3 illustrates an exemplary embodiment of a hazard mitigation robot 114. As illustrated, the hazard mitigation robot 114 has a housing 302. The housing may be fire resistant to enable the hazard mitigation robot 114 to operate in the presence of a fire without immediate damage. In order to travel from one location to another as was described with regard to the residence 200 of FIG. 2, a hazard mitigation robot 114 may be equipped with wheels 304, treads, legs, sleds, propellers, or other devices that enable the hazard mitigation robot 114 to move from place to place. In such embodiments, the wheels 304, etc. will be powered by one or more motors that receive instructions from a controller 306. In an exemplary embodiment, the hazard mitigation robot 114 is configured with a controller 306 that may further comprise a processor, software instructions, a location device such as a GPS, and position sensors. The hazard mitigation robot 114 may use the GPS to locate its position within a residence 200 or other area. In certain circumstances, a GPS receiver may be unable to reliably determine the position of the hazard mitigation robot 114. In such cases, the hazard mitigation robot 114 can use beacons positioned throughout an area to triangulate its position relative to sensors (204, 206, 208, 210, 212, and 214), or identify its position by mapping a structure using a gyroscopic sensor to determine its orientation and distance measurements obtained from the wheels 304 or other means for causing the hazard mitigation robot 114 to move from place to place. In certain exemplary embodiments, the hazard mitigation robot 114 may comprise range-finding devices such that the hazard mitigation robot 114 is able to determine the size and configuration of a room in which it is located. In certain embodiments, a memory of the hazard mitigation robot 114 may comprise a map or building layout that comprises room dimensions and designs. In such embodiments, the hazard mitigation robot 114 may determine its location using determined room sizes and configurations. In order to communicate with the monitoring system 102, the hazard mitigation robot 114 may comprise a receiver/transmitter (transceiver) 308 and an antenna 310 to enable wireless communication with the monitoring system 102. In certain exemplary embodiments, the monitoring system 102 comprises multiple transceivers to improve communications between the monitoring system 102 and the hazard mitigation robot 114. As illustrated, the hazard mitigation robot 114 is configured with sensors 312 and 314. Such sensors may be, without limitation, obscuration sensors, gas sensors, smoke sensors, temperature sensors, or flame detectors. The number of sensor may vary from a single sensor to a large number of sensors. Thus, the illustrated embodiment should not limit other embodiments to the relatively simple configuration shown in FIG. 3. In certain exemplary embodiments, sensors 312 and 314 may be audio detectors such as microphones, vibration sensors, or cameras. Additionally, the sensors 312 and 314 may be configured to transmit sound or light. In such embodiments, the sensor may communicate instructions to an occupant of an area and receive verbal instructions which cause the hazard mitigation robot 114 to perform certain actions (for example, turning on a light or communicating with a monitoring service and rescue personnel).

In certain exemplary embodiments, the hazard mitigation robot 114 will transmit received voice communications or sounds to a monitoring service such that a person or pet in the vicinity of the hazard mitigation robot 114 may be identified. In certain exemplary embodiments, a hazard mitigation robot 114 may comprise a fire suppression system 316. In an exemplary embodiment, such a fire suppression system 316 comprises a storage chamber 318 in which a fire suppressant 320 is stored until ready for use. When needed, the hazard mitigation robot 114 can cause the fire suppressant 320 to discharge through a nozzle 322. As is illustrated, the nozzle 322 can be positioned at various heights, including above the hazard mitigation robot 114, using an extendable arm 324 in order to reach a fire. For example, a fire located on a cooktop may be located higher than the hazard mitigation robot 114, necessitating a repositioning of the nozzle 322. Certain exemplary embodiments use other methods such as, without limitation, multiple nozzles, articulated arms, etc. In order to direct the fire suppressant effectively, the nozzle 322 may also be swiveled side to side and up and down. A flame sensor 332 may be used by the hazard mitigation robot 114 to identify a precise location of the flame such that the nozzle 322 can be more accurately directed to apply fire suppressant 320 to the flame. A flame sensor may be located at various locations such as, without limitation, on the body of the hazard mitigation robot 114, adjacent to the nozzle 322, or on a separate extendable arm or tower. Other types of sensor may also be used to identify the source of flame for purposes of directing the application of fire suppressant 320. Examples of such other sensor might include, but are not limited to, image capture devices, heat sensors, gas analyzers and so forth. As illustrated, such a sensor 332 is located adjacent to the nozzle 322 in certain exemplary embodiments, and may be extended along with this nozzle 322 as illustrated. Hazard mitigation robots 114 in certain exemplary embodiments may report the results of applying fire suppressant 320 as well as the flame characteristics and other data retrieved by sensors including the flame sensor. As noted herein, the hazard mitigation robot 114 is in communication with the monitoring system 102. As such, the results of the application in conjunction with flame characteristics can be accumulated by monitoring systems deployed to a plurality of different locations and best practices identified. These best practices can then be used to make improvements to the instructions stored in the hazard mitigation robot 114, improving the methods used as firefighting data is accumulated over time.

In certain exemplary embodiments, a heat sensor may be integrated into the flame sensor 332. In other embodiments, a heat sensor may be a separate installation. In these embodiments, the heat sensor may be used to monitor doors and walls as the hazard mitigation robot 114 moves through a structure. The hazard mitigation robot 114 can determine that a high level of heat exists that may be indicative of a fire and react accordingly. For example, if the hazard mitigation robot 114 is seeking to apply a fire suppressant 320, the hazard mitigation robot may follow instructions to move toward the detected high level of heat in order to locate a fire using the flame sensor 332, camera, or other sensor. In another example, if the hazard mitigation robot 114 is seeking to identify an escape route or lead someone to safely exit a structure, the hazard mitigation robot 114 may be programmed to avoid high levels of heat detected so as to protect the person or persons seeking to exit the structure. In still another exemplary embodiment, a hazard mitigation robot 114 may be used to map a structure ahead of emergency personnel, in such an embodiment, the hazard mitigation robot 114 may move through a structure while experiencing conditions unsuitable for a human searcher. While moving through the structure, the hazard mitigation robot 114 may locate individuals using the heat sensor, motion sensor, sound sensors, or other sensors capable of identifying occupants. In addition to human beings, pets could also be located. The hazard mitigation robot 114 may also identify hazards while moving through the structure. Hazards may include, but are not limited to, circumstances and conditions such as fires, dangerous gasses, or unauthorized occupants. While the hazard mitigation robot 114 is moving through the structure, information related to what occupants, conditions, or hazards detected may be transmitted to a receiver, stored by the memory of the hazard mitigation robot 114 or both. The receiver may be the monitoring system 102, a user, or emergency service providers. This information may be used to direct emergency service providers when they are entering the structure, to create a layout of the structure with indications of the occupants, conditions, or hazards detected, or both.

In certain exemplary embodiments, a hazard mitigation robot 114 may comprise an occupancy detector 326. The occupancy detector 326 may be used to alert emergency responders to the presence of a person or pet in the area of the hazard mitigation robot 114. Alternatively, the hazard mitigation robot 114 may utilize the occupancy detector 326 to determine if a sensor reading accurately detects a hazardous condition by interacting with the occupants of an area via voice queries as to the conditions present in the area. In certain exemplary embodiments, the hazard mitigation robot 114 may be equipped with lamps 328 to illuminate an area around the hazard mitigation robot 114. This can be used to allow cameras located in the hazard mitigation robot 114 to better capture images of the area surrounding the hazard mitigation robot 114. Lamps 328 may also be used to provide visibility to occupants in the vicinity of the hazard mitigation robot 114 in the event of a power outage or smoke filled room. In certain exemplary embodiments, the hazard mitigation robot 114 may be configured to illuminate the lamps 328, and provide instructions to occupants to follow the hazard mitigation robot 114 as the hazard mitigation robot 114 navigates along an escape route to lead occupants to safety exit the area of a fire or other hazardous condition. In such exemplary embodiments, the hazard mitigation robot 114 may receive building exit data such as the location of doors or egress windows obtained from building layout data stored in the building monitoring system 102. In other exemplary embodiments, the location of windows 224 and doors 228 may be obtained from window sensors 226 and door sensors 230. The hazard mitigation robot 114 and building monitoring system 102 can identify an exit or exits that are safe with regard to fire or other hazardous conditions detected using other sensors in communication with the monitoring system 102. In certain exemplary embodiments, the hazard mitigation robots 114 may be configured with devices useful to clear debris or barriers to an exit to be used to evacuate the building. In addition to sensors, fire suppression devices, and lighting, a hazard mitigation robot 114 may be equipped with survival items 330. Such items can include, without limitation, oxygen or bottled air, heat resistant coverings, flashlights, radios, first aid supplies, and the like. In some exemplary embodiments, the hazard mitigation robot 114 may be equipped with rescue devices that enable the hazard mitigation robot 114 to assist a victim to exit a dangerous area. For example, the hazard mitigation robot may be equipped with a wagon, sled, or other device into which a victim can be placed and removed from the dangerous area. In certain exemplary embodiments in which the hazard mitigation robot 114 is large, a space may be provided on or in the hazard mitigation robot which can accommodate a victim such that the hazard mitigation robot can evacuate the victim from the area of a fire.

In circumstances where an occupant is unresponsive, the hazard mitigation robot 114 may illuminate the area with lamps 328 and communicate with emergency responders to indicate that an occupant is in need of assistance while providing the location of that occupant to the emergency responders using the location of the hazard mitigation robot 114 determined using GPS or other methods of locating the hazard mitigation robot 114 described herein.

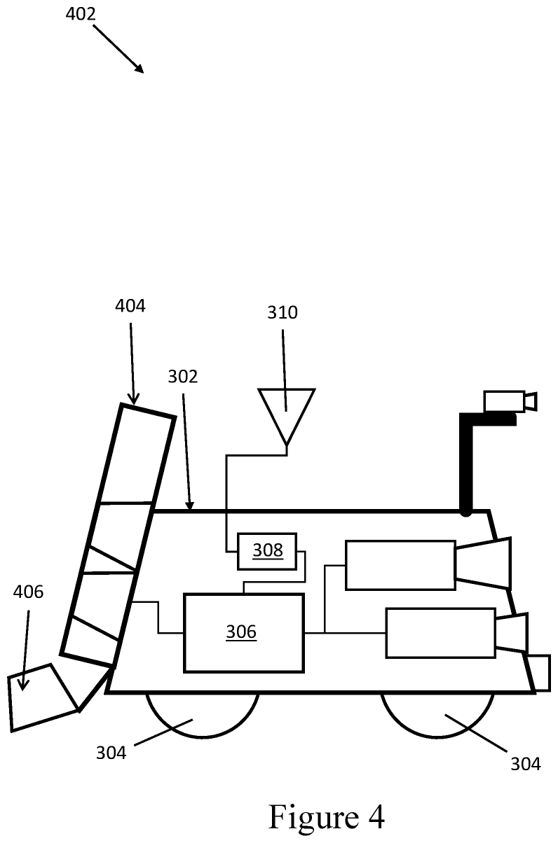

In certain exemplary embodiments, a hazard mitigation robot 114 may deploy sensors along its route to provide additional monitoring points within a structure or residence. As illustrated in the exemplary embodiment of FIG. 4, a robot 402 is configured with a dispenser 404. As illustrated in FIG. 3, the robot 402 comprises a housing 302. The robot 402 may be equipped with wheels 304, treads, legs, sleds, propellers, or other devices that enable the robot 402 to move from place to place. In such embodiments, the wheels 304, etc. will be powered by one or more motors that receive instructions from a controller 306. In an exemplary embodiment, the robot 402 is configured with a controller 306 that may further comprise a processor, software instructions, a location device such as a GPS, and position sensors. As was the case for the hazard mitigation robot of FIG. 3, in order to communicate with the monitoring system 102, the robot 402 may comprise a receiver/transmitter (transceiver) 308 and an antenna 310 to enable wireless communication with the monitoring system 102. In certain exemplary embodiments, the monitoring system 102 comprises multiple transceivers to improve communications between the monitoring system 102 and the robot 402. As illustrated, the robot 402 is configured with sensors 312 and 314. In the illustrated embodiment, the dispenser 404 is configured to deposit beacons 406 along a route taken by the robot 402. These beacons 406 may be used to monitor an evacuation route, identify changing conditions in the area of the beacon 406, or to guide rescue personnel along a path taken by the robot 402. In certain exemplary embodiments, the deployed beacons 406 may comprise light sources to illuminate an escape route. The deployed beacons 406 can comprise batteries and a wireless data transmitter such that data collected by a beacon can be transmitted to the monitoring system 102, the robot 402, or a remote monitoring center 232 for integration with data from other sensors (104, 106, 108, 110, and 112) such as those of a monitoring system 102. The robot 402 illustrated in FIG. 4 is shown with a dispenser only however, a hazard mitigation robot 114 may also be equipped with a dispenser 404 such as illustrated in FIG. 4.

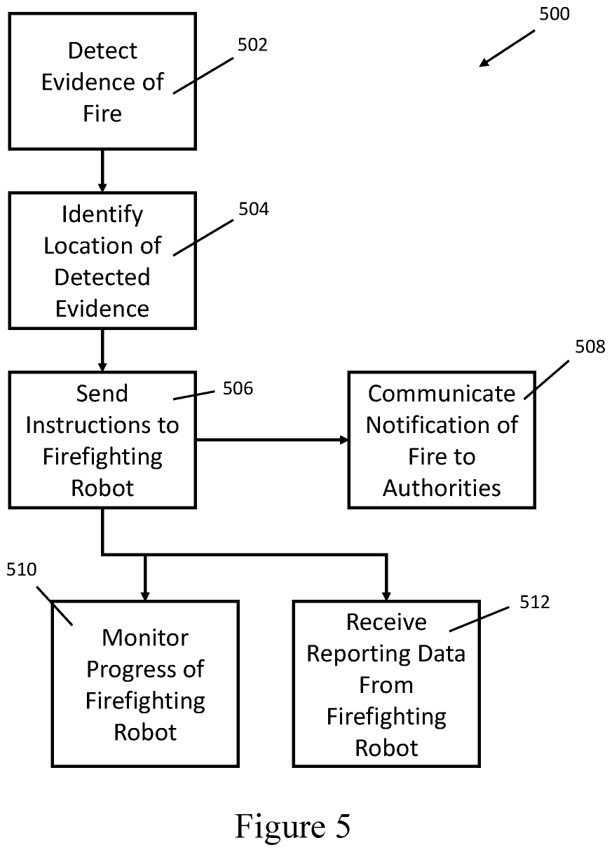

FIG. 5 illustrates a flowchart 500 of the steps taken by an exemplary embodiment. In step 502, a hazard mitigation system receives evidence of a fire. As was noted previously herein, fire detection can be achieved using sensors in communication with a monitoring system which is a component of the hazard mitigation system. Once evidence of a fire is detected, the monitoring system 102 can identify the location of the fire using the location of one or more sensors. Additionally, the monitoring system 102 can detect the progression or movement of a fire using the location of one or more sensors. Once this location is identified in step 504, a hazard mitigation robot is sent instructions in step 506 that cause the hazard mitigation robot to attempt to travel to the identified location. In addition to instructing the hazard mitigation robot, the monitoring system communicates a notification of fire detection to the authorities in step 508. In certain exemplary embodiments, the authorities may be able to communicate with occupants at the location of the fire using speakers and microphones incorporated into a hazard mitigation robot or sensors. In step 510, the monitoring system monitors the process of the hazard mitigation robot as it attempts to travel to the location of the detected fire. This provides the opportunity to modify the instructions transmitted to the hazard mitigation robot such that the hazard mitigation robot is instructed to take a different route, travel to a new location, or check on occupants known to be at a location other than the initial target of the hazard mitigation robot. In addition to progress of the hazard mitigation robot, as indicated by step 512, the monitoring system can receive reporting data from the hazard mitigation robot. For example, the hazard mitigation robot may detect previously unknown occupants or conditions not detected by the various sensors in communication with the monitoring system. Thus, using the hazard mitigation robot as a mobile sensor can dramatically increase the amount of coverage provided by sensors in communication with the monitoring system.

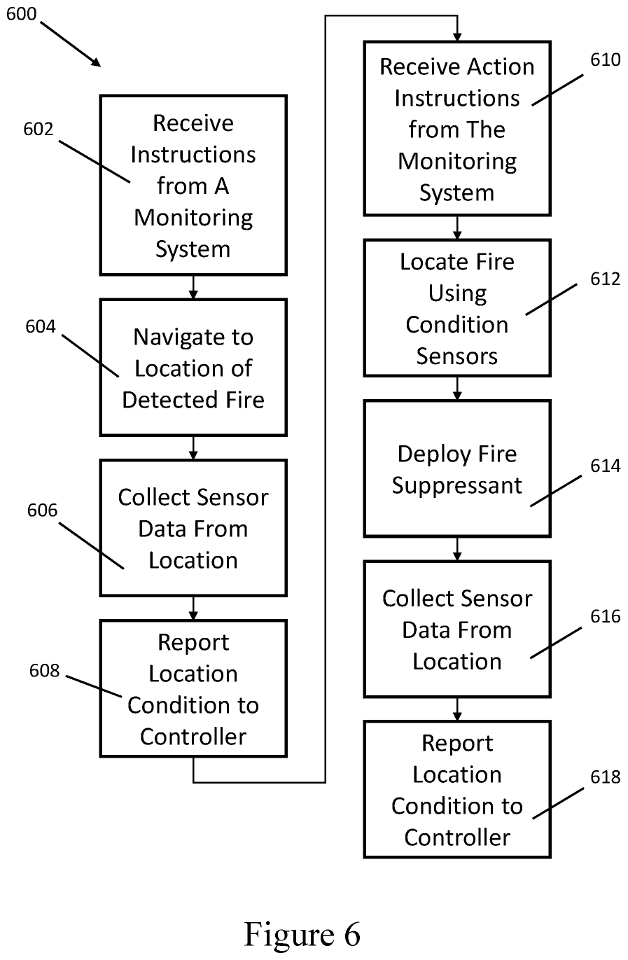

FIG. 6 is a flow chart 600 illustrating the steps taken by a hazard mitigation robot in an exemplary embodiment. In step 602, the hazard mitigation robot receives instructions from the monitoring system. As noted herein, the instructions may be provided wirelessly. However, in certain exemplary embodiments, the instructions may be delivered to a docking station where the hazard mitigation robot recharges while not in use. The instructions may provide a detailed process for traveling to the location of a detected fire. For example, the instructions may cause the hazard mitigation robot to travel forward 15 feet, turn 30 degrees to the left, travel 10 feet, etc. In other exemplary embodiments, the instructions may simply provide a destination. For example, travel to the living room. In other exemplary embodiments, the instructions may be a series of waypoints, For example, travel to the west end of the hallway, from the west end of the hallway, travel to the front door, from the front door, travel to the kitchen, etc. The level of detail may be dependent upon such things as the amount of autonomous capability of the hazard mitigation robot, the complexity of the environment, detected hazards along a possible path, and other factors such as occupancy levels of an area. The hazard mitigation robot then navigates to the desired location in step 604. In step 606, the hazard mitigation robot may collect sensor data from the location to which it has been sent. In some exemplary embodiments, sensor data may also be collected as the hazard mitigation robot navigates to the desired location in step 604. In some exemplary embodiments, the hazard mitigation robot reports the collected sensor data to the monitoring system in step 608. The monitoring system then processes the data to determine conditions at the location of the hazard mitigation robot. The monitoring system then sends additional instructions to the hazard mitigation robot in step 610. In certain exemplary embodiments, the hazard mitigation robot may determine next actions without additional instructions from the monitoring system. This may be the case when the hazard mitigation robot has a sufficient level of machine intelligence to determine the next actions required. In other cases, the hazard mitigation robot may be unable to maintain a communication connection with the monitoring system and thus, the processor of the hazard mitigation robot may be the best decision making device available and therefore determine conditions at the location of the hazard mitigation robot without reliance on the monitoring system. In such an exemplary embodiment, the hazard mitigation robot uses a condition sensor such as a flame detection or other type of device to locate the source of a fire in step 612. The flame detection process may be performed using a camera, which is a part of or in communication with the hazard mitigation robot. The camera may be adapted to find the source of a fire using visual and thermal imaging sensors. In certain exemplary embodiments thermal sensors are used alone or in conjunction with cameras to detect a source of the fire. Once identified, the hazard mitigation robot deploys a fire suppressant to extinguish the fire. In certain exemplary embodiments, additional sensors may be deployed to determine what type of fire has been detected. For example, is the fire a wood or paper fire, a grease fire, or a fire in which plastics or flammable liquids are burning? This information is used in an exemplary embodiment to provide instructions to the hazard mitigation robot with regard to how to most effectively extinguish the fire. For example, in some instances, the most effective method may involve applying a suppressant material to the base of the fire while other fire types may be more effectively extinguished by applying a covering foam or other suppressant materials or methods. Once the flame source is identified, the hazard mitigation robot deploys a fire suppressant material in step 614. The hazard mitigation robot collects additional sensor data in step 616 to determine the condition at which the hazard mitigation robot is located. This data is communicated to the monitoring system in step 618. If needed, the monitoring system 102 can provide sensor data to emergency responders, occupants of the location, or additional fire suppression devices (for example, without limitation, a sprinkler system or a second hazard mitigation robot).

As noted, a system comprising a hazard mitigation robot 114 may be configured to utilize more than one hazard mitigation robot 114. For example, multi-story structures may be equipped with one or more hazard mitigation robots for each floor. In an exemplary embodiment the number of hazard mitigation robots 114 may be determined by the size of each floor or area or the types of barriers that are present in a structure. For example, structures with multiple rooms or doors may benefit from having more than one hazard mitigation robot 114 such that if one hazard mitigation robot 114 were to become trapped by a door are other barrier, another hazard mitigation robot 114 may be directed to the area from which the first hazard mitigation robot 114 is prevented from entering.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations.

The hardware and data processing components described herein as being used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation or embodiment disclosed herein can be combined with any other implementation or embodiment, and references to “an implementation,” “some implementations,” “one implementation,” “an embodiment,” “some embodiments,” “certain embodiments,” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation or embodiment can be combined with any other implementation or embodiment, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

References to “or” can be construed as inclusive so that any terms described using “or” can indicate any of a single, more than one, and all of the described terms. A reference to “at least one of ‘A’ and B” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, or orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions, and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations, and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

What is claimed is:

1. A system for detecting and fighting fires, the system comprising:
a plurality of building sensors;
a monitoring system that receives data from the plurality of building sensors, the monitoring system comprising a receiver and a transmitter;
a hazard mitigation robot, the robot comprising:
a drive system configured to move the robot from a first location to a second location;
a processor;
a plurality of sensors;
a receiver/transmitter in communication with the monitoring system;
instructions that when performed by the monitoring system, cause the monitoring system to:
receive data from the plurality of building sensors;
analyzing the received data to determine if a fire is present;
identify the location of the fire;
provide instructions to the hazard mitigation robot;
instructions that when performed by the processor of the hazard mitigation robot, cause the hazard mitigation robot to:
receive navigation instructions from the monitoring system which comprise the location of the fire;
navigate to the location of the fire;
receive data from a condition sensor;
analyze the received condition sensor data and apply a fire suppressant based on the results of the analysis of the received condition sensor data.

2. The system of claim 1, further comprising instructions that cause the hazard mitigation robot to receive data from an occupancy sensor and transmit occupancy data to the monitoring system.

4. The system of claim 2, wherein the hazard mitigation robot further comprises a flame sensor configured to detect the source of a fire.

5. The system of claim 4, wherein the hazard mitigation robot applies the fire suppressant using the flame sensor such that the fire suppressant is directed at the source of the flame.

6. The system of claim 1, further comprising instructions that cause the hazard mitigation robot to receive additional data from one of the plurality of sensors comprises by the hazard mitigation robot after the fire suppressant has been applied and transmit fire status data to the monitoring system that indicates the sensor detected a continued presence of one of fire or combustion.

7. The system of claim 6, further comprising instructions that cause the monitoring system to transmit the continued presence of fire or combustion to a receiving station.

8. The system of claim 7, comprising instructions that cause the monitoring system to receive instructions from the receiving station that cause the hazard mitigation robot to transmit image data to the receiving station.

9. The system of claim 1, wherein the hazard mitigation robot transmits sensor information to the monitoring system as the hazard mitigation robot navigates to the location of the fire.

10. The system of claim 9, wherein the monitoring system comprises instructions that when executed, cause the monitoring system to analyze the sensor information transmitted by the hazard mitigation robot, detect a second hazardous condition, and transmit the location of the second hazardous condition to a receiving station.

11. A method of mitigating a hazardous condition comprising:
receiving from a monitoring system an indication that a first hazardous condition is present, the monitoring system comprising a plurality of sensors;
determining the location of the first hazardous condition using known locations of the plurality of sensors;
providing an instruction to a hazardous condition mitigation robot that notifies the hazardous condition robot of the location of the first hazardous condition;
traveling to by the hazardous condition mitigation robot to the location of the first hazardous condition;
performing an action by the hazardous condition mitigation robot that reduces the severity of the first hazardous condition;
reporting by the hazardous condition mitigation robot, the severity of the first hazardous condition after performance of the action to reduce the severity of the first hazardous condition.

12. The method of claim 11, wherein the hazardous condition mitigation robot collects data representing conditions along its path of travel and transmits the collected data to the monitoring system.

13. The method of claim 12, wherein the monitoring system analyzes the data transmitted by the hazardous condition mitigation robot representing conditions along its path of travel and provides instructions to the hazardous condition mitigation robot to mitigate a second hazardous condition determined by the analysis of the data.

14. The method of claim 11, wherein the hazardous condition mitigation robot determines the source of the first hazardous condition using sensors contained by the hazardous condition mitigation robot.

16. A system for reducing the severity of a hazardous condition, the system comprising:
a monitoring system that receives data from a plurality of building sensors, the monitoring system comprising a receiver and a transmitter;
a hazard mitigation robot, the robot comprising:
a drive system configured to move the robot from a first location to a second location;
a processor;
a plurality of sensors;
a receiver/transmitter in communication with the monitoring system;
a plurality of sensor beacons;
a beacon dispenser;
instructions that when performed by the monitoring system, cause the monitoring system to:
identify a first hazardous condition and determine its location from data received from a plurality of building sensors;
provide instructions to the hazard mitigation robot that cause the processor of the hazard mitigation robot to navigate to the location of the first hazardous condition while receiving data from the plurality of sensors comprised by the hazard mitigation robot;
instructions that when performed by the processor of the hazard mitigation robot, cause the hazard mitigation robot to deploy at least one of the plurality of sensor beacons using the beacon dispenser;
instructions that when performed by the monitoring system, cause the monitoring system to:
receive data from a deployed sensor beacon comprising the location of the sensor beacon and conditions detected by the sensor beacon;
receive data from the data from the plurality of sensors comprised by the hazard mitigation robot;
analyze received data from the deployed sensor beacon and plurality of sensors comprised by the hazard mitigation robot to determine if a second hazardous condition is present; and
provide additional instructions to the hazard mitigation robot to cause the hazard mitigation robot to travel to a location of the second hazardous condition.

17. The system of claim 16, further comprising instructions that cause the monitoring system to track the location of the hazard mitigation robot and create a report of conditions detected by the sensors of the hazard mitigation robot as the robot navigates to a location at which a hazardous condition is detected.

18. The system of claim 16, further comprising instructions that cause the hazard mitigation robot to:
receive sensor data when the robot is at the location of the first hazardous condition;
analyze the received sensor condition to determine if the first hazardous condition is present when the robot arrives at the location of the first hazardous condition.

19. The system of claim 18, further comprising instructions that cause the hazard mitigation robot to determine if the severity of the first hazardous condition has changed since it was identified by the monitoring system.

20. The system of claim 16, comprising instructions that cause the monitoring system to receive instructions from a receiving station that cause the hazard mitigation robot to transmit image data representing an image of the hazardous condition to the receiving station.
